(19) United States
(12) Patent Application Publication
(10) Pub. No.: US 2007/0227386 A1
(43) Pub. Date: Oct. 4, 2007

(54) Plate processing system and method

(76) Inventor: Mark D. McGaire, Surrey (CA)

Correspondence Address: Mark G. Bocchetti;Patent Legal Staff, Eastman Kodak Company, 343 State Street, Rochester, NY, 14650-2201, US

(21) Appl. No.: 11/396,516

(22) Filed: Apr. 3, 2006

(51) Int. Cl. B41F 27/12; B41L 47/14

(52) U.S. Cl. 101/477

(57) ABSTRACT

Printing plate processing systems and methods are provided. One of the methods comprises positioning a plurality of printing plates on an imaging support surface; forming an image on each printing plate at a location that is separated by a main scanning axis separation from an alignment edge that is perpendicular to a main scanning axis; transporting the plurality of printing plates to a position proximate to a punching area having punch drivers adapted to form alignment features in a printing plate; individually advancing each one of the plurality of printing plates until the alignment edge thereof comes into contact with a registration feature in the punch area that is located so that the printing plate will be positioned to have alignment features formed by the punch drivers at a position along the main scanning axis that is determined based upon the main scanning axis separation for the selected printing plate.

### CROSS-REFERENCE TO RELATED APPLICATIONS

This application is related to U.S. Ser. No. (Attorney Docket 92342), entitled POST-IMAGING PUNCHING APPARATUS AND METHOD, in the name of Mark D. McGaire; U.S. Ser. No. (Attorney Docket 92343), entitled PUNCHING CHIP-EXTRACTION SYSTEM, in the names of Mark D. McGaire et al.; and U.S. Ser. No. (Attorney Docket 92358), entitled IMAGING AND PUNCHING THERMAL CONTROL SYSTEM, in the name of Mark D. McGaire, all filed concurrently herewith.

### FIELD OF THE INVENTION

This invention relates in general to an imaging and punching system and related method for forming printing plates.

### BACKGROUND OF THE INVENTION

Contact printing using high volume printing presses remains the most economical method for printing a large number of copies of an image. Contact printing presses utilize printing plates to apply ink to a receiver medium to form an image on the receiver medium. Such printing plates have a printing surface with a pattern of markings representing the image to be printed. Prior to printing, the printing plate is fixed to a plate-mounting surface within the printing press. During printing, ink is applied to the printing plate and the printing plate is brought into contact with a receiver medium such as paper. An ink pattern is thereby transferred to the receiver medium forming an image on the receiver medium.

It is essential to ensure that the contact printing plate is properly aligned with the receiver medium during printing. To accomplish this, it is necessary to properly align the printing plate on the mounting surface of the printing press and to properly adjust the position of the printing plate on the plate-mounting surface. A printing plate that is properly aligned and positioned is known in the art as being “in registration.”

In certain types of printing, two or more printing plates are used to apply ink to form a single image on a receiver medium. Typically, each printing plate applies a differently colored ink to the receiver medium. In this way, the image formed on the receiver medium can contain different colors and color combinations to provide a multi-color or full color image. It will be understood that each printing plate must be in registration with all other printing plates when the multi-color or full-color image is printed. If the printing plates are not in registration, the image will appear out of focus and the colors in the image will be incorrect.

Most commercial printing presses position printing plates using alignment features on the printing plates. These alignment features are typically provided on the printing plate in a punching process that occurs either before or after forming an image on the printing plate. It will be appreciated that it is necessary to ensure that a desired geometric relationship is provided between the alignment features on each printing plate and the image formed thereon. When there are variations in the desired geometric relationships from one plate to another, plate-to-plate registration problems arise that can cause the above-described problems in the printed image.

Variations in the geometric relationship between location of the image on a printing plate and the alignment features can arise when separate devices are used to image and to punch the printing plates. For example, an image can be formed on a printing plate at a place and time that is substantially separated from the place and time at which the printing plate is punched. Accordingly, environmental and other conditions influencing the geometry of a printing plate at a time of image formation can be substantially different from environmental conditions at the time at which locating features such as punch holes or other forms are formed on the printing plate.

Thus, there is a need in the art for better integration between printing plate imaging apparatuses and punching systems so that a printing plate can be conveniently be imaged and punched without undue delay.

Further, differences in the way in which printing plates are positioned for imaging and punching can induce geometric variations that cause plate-to-plate registration problems. Specifically, printing plates are positioned relative to alignment surfaces on the surfaces that support the printing plates during imaging. The printing plates are then positioned relative to different alignment surfaces when the printing plates are positioned for punching. It will be appreciated that where the arrangement of alignment surfaces used during printing, and the arrangement of alignment surfaces used during formation of the alignment features on the printing plate do not correspond, plate-to-plate geometric variations can arise that can result in unsatisfactory printed output.

Accordingly, what is also needed in the art are new systems and methods that provide better coordination between the imaging process and alignment feature formation process so as to reduce plate-to-plate variations.

### SUMMARY OF THE INVENTION

In one aspect of the invention, a printing plate processing system is provided. The printing plate processing system comprises: an imaging system having an imaging head adapted to record an image on each of a plurality of printing plates loaded on an imaging support surface during an imaging operation; the imaging support surface having a plurality of imaging alignment surfaces with each printing plate being associated with a set of imaging alignment surfaces and against which an alignment edge of each printing plate can be positioned during the imaging operation; the plate exchange surface and plate exchange actuator operable to transfer the plurality of printing plates between the imaging surface and the transfer support surface for concurrent processing; a transfer assembly having a transfer support surface sized to hold the plurality of printing plates at the same time and a transfer surface positioning system defining a movement path for the transfer support surface between a transfer area wherein printing plates can be exchanged with a plate transfer support surface and a punch area; a plurality of punch registration members arranged in the punch area in a distribution that allows the alignment edge of a single one of a plurality of printing plates moved to the punching area to be positioned against any of the punch registration members so that the received printing plate is positioned at one of a variety of positions relative to a plurality of punch drivers adapted to automatically punch alignment features in the positioned printing plate; a plate positioning system operable to individually position each of the printing plates against at least one of the punch registration members; and a controller adapted to cause the imaging system to record an image on each of the printing plates when each printing plate is positioned for imaging; the controller further causing the plate exchange surface and plate exchange actuator to exchange printing plates between the transfer support surface and the imaging surface; the controller further causing the plate positioning system to position the alignment surface of each of the printing plates against at least one of the punch registration members selected to correspond with the set of imaging alignment surfaces associated with the printing plate, and to cause at least one of the punch drivers to form an alignment feature in each positioned printing plate.

In another aspect of the invention, a printing plate processing system is provided. The printing plate processing system comprises: an imaging support surface adapted to concurrently support both of a first printing plate and a second printing plate with an alignment edge of the first printing plate being positioned relative to a first set of imaging alignment surfaces and with an alignment edge of the second printing plate being positioned against a second set of imaging alignment surfaces; an imaging head adapted to form images on the first and second printing plates so positioned; a transfer assembly having a transfer support surface adapted to receive the first and second printing plates and a transfer surface positioning system adapted to provide controlled movement of the transfer support surface from a position where the first and second printing plates can be exchanged with the imaging support surface and a punch position; a plurality of punch registration members disposed on a punching support surface to engage an alignment edge of a single on of the plurality of printing plates on the transfer support surface when the transfer support surface is at the punch; a plurality of punches and associated punch actuators positioned with respect to the plurality of punch registration members, the actuators being activatable to cause selected ones of the punches to form alignment features on a printing plate positioned against any of the plurality of punch registration members; a first electronic sensor generating a first signal when the transfer support surface is at the punching position; a controller operable for detecting the first signal, and in response thereto, cause: a plate positioning system to position the first printing plate in an aligned relationship with registration members selected from the plurality of punch registration members that correspond with the first set of imaging alignment surfaces; a punch driver to activate the at least one of the punch actuators to punch the first printing plate so that alignment features are formed on the first plate in a location that is based upon the location of the alignment edge of the first printing plate that engages the punch registration members selected for the first printing plate; the plate positioning system further being adapted to reposition the first printing plate apart from the punch area after punching of the first printing plate and to position the second printing plate in an aligned relationship with registration members that correspond with the second set of imaging alignment surfaces; and a punch driver to activate at least one of the punch actuators to punch the second printing plate so that alignment features are formed on the second plate in a location that is based upon the location at which the alignment edge of the second plate engages the registration members selected for the second printing plate.

In another aspect of the invention, a printing plate processing system is provided. The processing system comprises: an imaging drum having an external surface, the imaging drum being connected to a motor to controllably rotate the drum along a scanning axis and having sufficient length along a sub-scanning axis to receive more than one printing plate; at least one imaging head adapted to form images on printing plates loaded on the external surface; a transfer assembly adapted to automatically move a plurality of printing plates from the external surface of the imaging drum proximate to the punching position; a plate exchange surface and plate exchange actuator operable to transfer the plurality of printing plates between the imaging surface and the transfer support surface; a plurality of punches each associated with a punch actuator; the punches and punch actuators being adapted to punch any of a set of differently located alignment features in a printing plate that is positioned in one of a plurality of punching positions; a printing plate positioner having an electrically controlled actuator and a contact surface movable by the actuator to advance only one of the printing plates at a time to one of the plurality of punching positions; a first electronic sensor generating a first signal when the plurality of printing plates is loaded onto the external surface of the imaging drum; and a controller operable detect the first signal and, in response thereto, to cause the motor and imaging head to cooperate to form images on the plurality of imaging plates loaded on the external surface of the imaging drum, the controller further being operable to cause the transfer support surface to receive the printing plates from the drum after the images have been formed on the plurality of printing plates and to position each printing plate proximate to the punching position, the controller further causing selected ones of the punch drivers to form alignment features in each of the plurality of printing plates after an alignment edge of the printing plate has been positioned along a sub-scanning axis so that when the printing plate is advanced along the main scanning axis, the alignment surface of printing plate contacts at least one of the punch registration members to position the printing plate along the main scanning axis at one of the punching positions; the at least one contacted punch registration member selected to position the printing plate so that alignment features can be formed therein at a location that has a desired correspondence along a main scanning axis with the image formed on the printing plate.

In yet another aspect of the invention, a method is provided for positioning a printing plate for formation of alignment features therein, the method comprising the steps of: positioning a plurality of printing plates on an imaging support surface; forming an image on each printing plate at a location that is separated by a main scanning axis separation from an alignment edge that is perpendicular to a main scanning axis; transporting the plurality of printing plates to a position proximate to a punching area having punch drivers adapted to form alignment features in a printing plate; individually selecting each one of the plurality of printing plates; and advancing each selected one of the plurality of printing plates until the alignment edge thereof comes into contact with a registration feature in the punch area that is located so that the printing plate will be positioned to have alignment features formed by the punch drivers at a position along the main scanning axis that is determined based upon the main scanning axis separation for the selected printing plate.

### BRIEF DESCRIPTION OF THE DRAWINGS

The invention and its objects and advantages will become apparent upon reading the following detailed description and upon reference to the drawings, in which:

FIG. 1 is an illustration of one embodiment of a printing plate processing system;

FIG. 2 is a perspective view of an imaging head and imaging support surface of a type useful with the embodiment of FIG. 1;

FIG. 3 is a side view of the printing plate processing system of FIG. 1 with transport support surface in a transfer position; and

FIG.4 is a side view of the printing plate processing system of FIG. 1 with the transport support surface in a punch position.

FIG. 5 is a top view of the printing plate processing system of FIG. 1 with a single printing plate loaded on the transfer support surface;

FIG. 6 is a top view of the printing plate processing system of FIG. 1 with a plurality of printing plates loaded on the transfer support surface;

FIGS. 7A-7C illustrate schematic elevation views one possible embodiment of a printing plate transfer support surface and actuator; and

FIG. 8 illustrates a top view of the printing plate processing system of FIG. 1, with one of a plurality of printing plates positioned for punching and another moved away from a punching position.

### DETAILED DESCRIPTION OF THE INVENTION

While the present invention will be hereinafter described in connection with a preferred embodiment thereof, it will be understood that it is not intended to limit the invention to that embodiment. On the contrary, it is intended to cover all alternatives, modifications and equivalents as may be included within the spirit and scope of the invention, as defined by the appended claims.

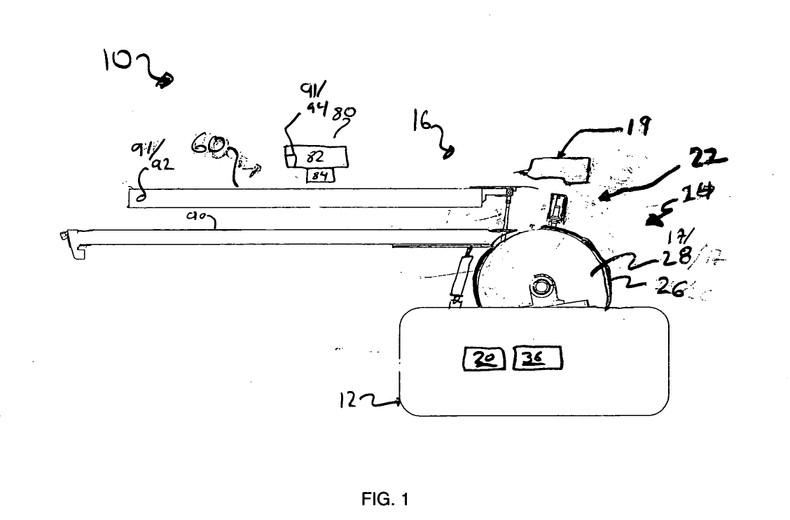

FIGS. 1-4 illustrate a first embodiment of a printing plate processing system 10. In the embodiment of FIGS. 1-4, printing plate processing system 10 comprises a frame 12 supporting an imaging system 14, a transfer assembly 16, a plate exchange surface 17, a plate exchange actuator 18, an alignment surface punch system 19, and a controller 20.

Imaging system 14 comprises an imaging head 22 adapted to take image-forming actions within an image forming area of an imaging support surface 28 so that an image can be formed on each of a plurality of printing plates loaded within the image forming area on imaging support surface 28. In the embodiment illustrated, the plurality of printing plates loaded on imaging support surface 28 comprises a first printing plate 24 and a second printing plate 26. However, this is not limiting and in other embodiments imaging support surface 28 may be capable of holding a plurality of more than two imaging plates in a manner that allows imaging head 22 to form images on each of the more than two printing plates held thereby.

Imaging head 22 generates one or more modulated light beams or channels that apply image modulated energy onto printing plates 24 and 26 along a sub-scanning axis SSA while a motor 36 or other actuator moves the imaging support surface 28 along a main scanning axis MSA such that image forming actions can be taken over an image forming area of imaging support surface 28 in which printing plates 24 and 26 are located.

Imaging head 22 is illustrated as providing two light emission channel sources 30 and 32 which can each comprise for example a source of laser light and laser modulation systems of a kind known to those of skill in the art (not illustrated) each capable of taking image forming actions on printing plates located within the image forming area. In some embodiments, light emission channel sources 30 and 32 can be independently controlled, each source applying modulated energy tone of printing plates 24 and 26. In yet other embodiments of this type, a single light emission channel source can be used to generate a modulated light beam that can be directed across the entire image forming area.

In alternative embodiments, not illustrated, other types of imaging technology can be used in imaging head 22 to form an image pattern on printing plates 24 and 26. For example and without limitation, thermal printing plate image forming techniques known to those of skill in the art can be used.

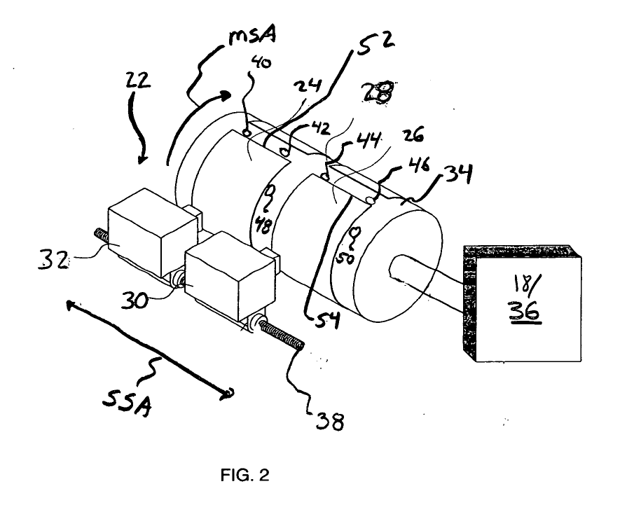

In the embodiment of FIGS. 1-4, imaging support surface 28 illustrates an external drum type of imaging surface having a generally cylindrical exterior surface 34. Accordingly in the embodiment of FIGS. 1 and 2, main scanning axis MSA is illustrated as extending along an axis that is parallel to a direction of rotation of exterior surface 34. However, in other embodiments, imaging support surface 28 can comprise an internal drum or a flatbed. In the external drum embodiment illustrated, printing plates 24 and 26 are held on exterior surface 34 by clamping forces, electrostatic attraction, vacuum force or other attractive forces supplied respectively by plate clamps, electrostatic systems, vacuum systems or other plate attracting systems (not illustrated).

During imaging operations, controller 20 causes image modulated beams of light from imaging head 22 to be scanned over the imaging forming area by a combination of operating a main scanning motor 36 to rotate imaging support surface 28 along main scanning axis MSA and translating imaging head 22 in the sub-scanning direction by causing rotation of a threaded screw 38 to which light emission channel sources 30 and 32 are attached in a manner that causes them to advance in a linear fashion down the length of threaded screw 38 as threaded screw 38 is rotated. In some embodiments, light emission channel sources 30 and 32 can be controlled to move independently of one another along main scanning axis MSA. Other mechanical translation systems known to those of skill in the art can be used for this purpose. Alternatively, other well-known light beam scanning systems, such as those that employ rotating mirrors, can be used to scan image modulated light across the image forming area of imaging support surface 28.

As is shown in greater detail in FIG. 2, exterior surface 34 has imaging alignment surfaces including first imaging alignment surfaces 40 and 42 and second imaging alignment surfaces 44 and 46 that are associated, respectively, with printing plates 24 and 26 and against which each associated printing plate can be positioned during said imaging operation to locate printing plates 24 and 26 along main scanning axis MSA. In this embodiment, main scanning axis MSA is the axis of rotation of exterior surface 34 of imaging support surface 28.

First imaging alignment surfaces 40 and 42 are located so that when an alignment edge 52 of first printing plate 24 is placed against first imaging alignment surfaces 40 and 42, first printing plate 24 is positioned at a preferred location along main scanning axis MSA for image formation thereon. Similarly, second imaging alignment surfaces 44 and 46 are located so that when an alignment edge 54 of second printing plate 26 is placed against second imaging alignment surfaces 44 and 46, first printing plate 24 is positioned at a preferred location along main scanning axis MSA for image formation.

First imaging alignment surfaces 40 and 42 are arranged to help control the position of first printing plate 24 and second printing plate 26 along main scanning axis MSA. This alignment can be provided in two ways. In a preferred embodiment, imaging head 22 has an integral edge detector 23 that is adapted to sense lateral edges 25 and 27 printing plates 24 and 26 as imaging head 22 is scanned past first printing plate 24 and second printing plate 26 during imaging operations. Controller 20 receives signals from edge detector 23 and adjusts imaging operations so that images are formed on printing plates 24 and 26 in precise relation to the sensed lateral edges 25 and 27 of printing plates 24 and 26 respectively. Typically, integral edge detector 23 comprises an optical sensor that detects the edge based upon differences in an amount of light reflected thereby. However, edge detector 23 can take other forms known to those of skill in the art including magnetic field detectors, electrical sensors and contact detectors.

Alternatively, alignment along the sub-scanning axis SSA during imaging can be provided by additional axis alignment surfaces 48 and 50 are illustrated in phantom in FIG. 2. Where used, additional axis alignment surfaces 48 and 50 are positioned so that the lateral edges of first printing plate 24 and second printing plate 26 other than alignment edges 52 and 54 can be placed against additional axis alignment surfaces 48 and 50 to help accurately position first printing plate 24 and second printing plate 26 along sub-scanning axis SSA.

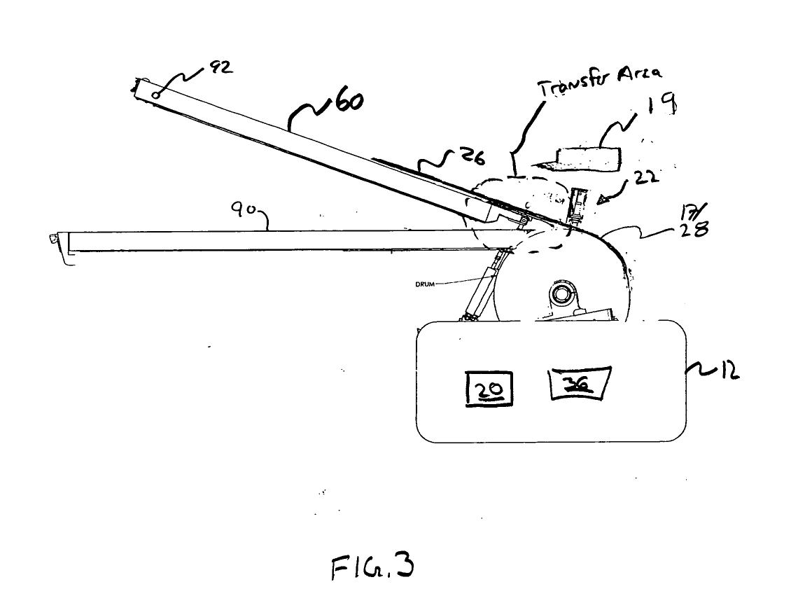

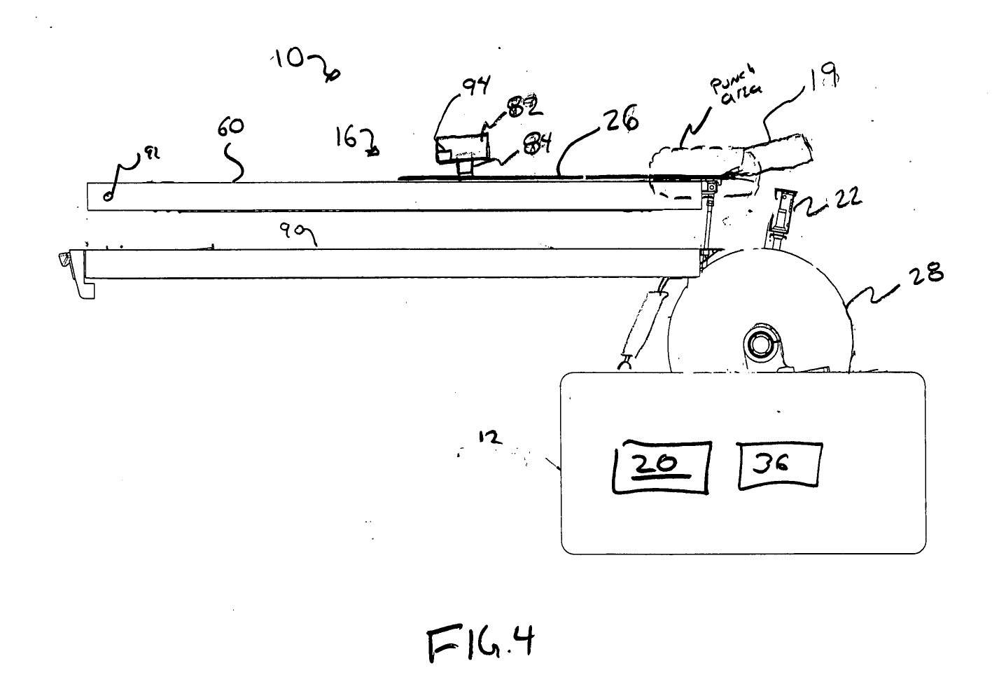

Printing plate processing system 10 has a transfer assembly 16 with a transfer support surface 60 and a positioning system 62. Transfer support surface 60 is sized to receive, hold and/or deliver the plurality of printing plates at the same time. Transfer support positioning system 62 is connected between frame 12 and transfer support surface 60 and defines a movement path for transfer support surface 60 between a transfer position shown in FIG. 3 and a punch position shown in FIG. 4.

When transfer support surface 60 is in the transfer position, the plurality of printing plates e.g. printing plates 24 and 26 can be transferred between imaging support surface 28 and transfer support surface 60. Depending on the desired flow of printing plates through system 10, printing plates 24 and 26 can be transferred from transfer support surface 60 to imaging support surface 28 or from imaging support surface 28 to transfer support surface 60 when transfer support surface 60 is in the transfer position.

When transfer support surface 60 is in the punch position, alignment edges 52 and 54 of printing plates 24 and 26 are positioned proximate to a punch area 70. Punch area 70 is adapted to receive a single printing plate and to form alignment features in the received printing plate. In the embodiment of FIGS. 1-4, punch area 70 comprises punch drivers 72, each comprising at least one punch 73, each associated with punch actuators 74 controlled by signals from controller 20. Punches 73 are arranged to punch holes or detents or other forms in printing plates 24 and 26 that can be used to locate printing plates 24 and 26 in the printing presses into which they will be installed. While it is common in the industry for punches 73 to be used to form such alignment features and for printing presses to use punch formed features to align printing plates, it will be appreciated that there are a variety of other ways in which punch drivers 72 can form alignment surfaces in printing plates 24 and 26. For example, in other embodiments, punch area 70 can form alignment features using punch drivers 72 that employ other techniques to form the alignment features including for example and without limitation, laser cutting, thermal cutting, drilling, chemical etching, ablation, and other well known mechanical, chemical and electrical processes.

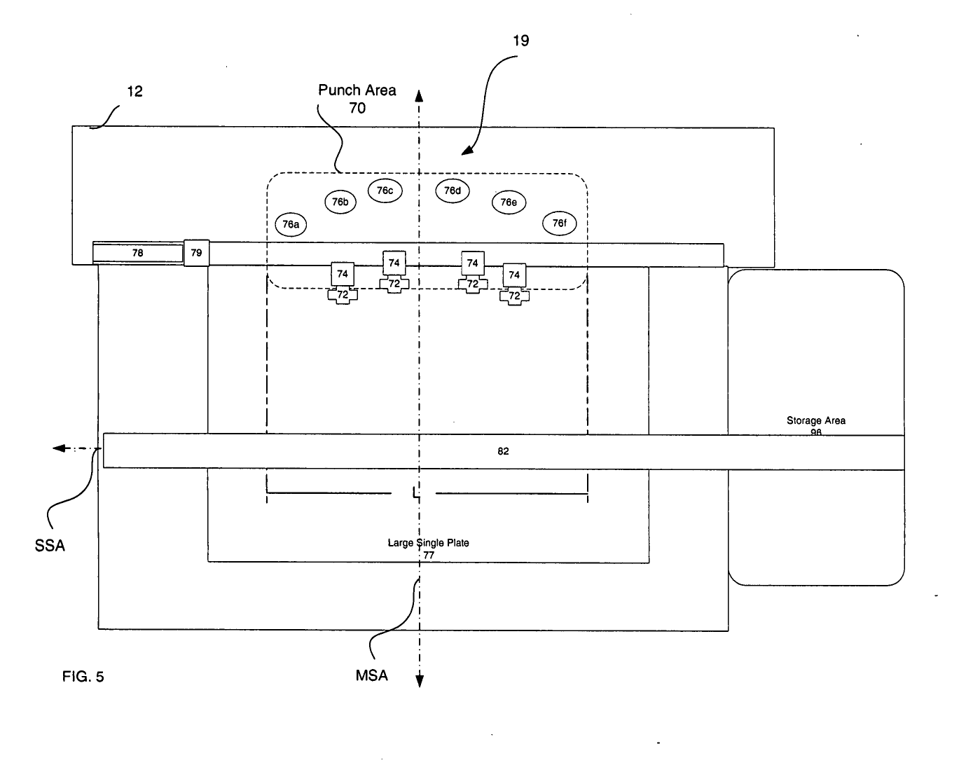

FIG. 5 shows an example of a punch area 70 in one embodiment of a printing plate processing system 10. In this embodiment, a plurality of punch registration members 76 are arranged in punch area 70 so that the alignment edge of a received printing plate can be positioned against at least one of a plurality of punch registration members 76. Punch registration members 76 are positioned so that when an alignment edge of a received printing plate is positioned against one or more of the punch registration members 76, the printing plate will be positioned at one of a variety of positions relative the punch drivers 72. This precisely positions the printing plate so that alignment features can be formed therein at a preferred location along the main scanning axis MSA relative to the printing plate.

As is also shown in FIG. 5 a lateral alignment feature 78 is provided. Lateral alignment feature 78 is adjustably positioned along the sub-scanning axis by a lateral displacement system 79 such a motor and transmission arrangement (not shown) or a pneumatic or hydraulic cylinder (not shown). In operation, lateral alignment feature 78 is positioned against the lateral edge of a printing plate received in punch area 70 to position printing plate 77 at a desired location along the sub-scanning axis relative to the punch drivers 72 used to form alignment features in the received printing plate. The position of lateral alignment feature 78 at the time of punching is determined by controller 20 and controller 20 is adapted to select the position so that the alignment features formed by punch drivers 72 are located at a precise geometric relationship with the lateral edge of the printing plate and therefore are also located at a precise geometric relationship with the image formed on the printing plate.

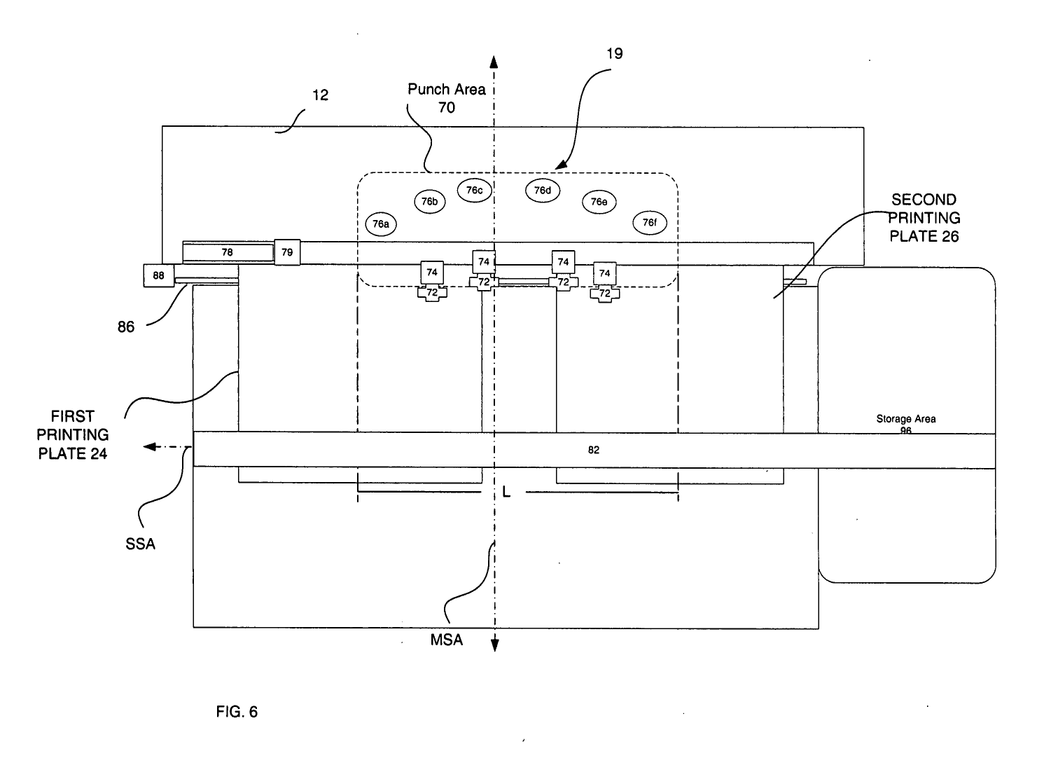

As is illustrated in FIG. 5, punch area 70 is advantageously positioned at a central position relative to the sub-scanning axis SSA so that when printing plate processing system 10 is used to form alignment features in a single large printing plate LP, punch area 70 will be pre-positioned to form alignment features in such a large printing plate without repositioning substantial portions of large plate LP off of the transfer support surface 60. However, a punch area 70 that is positioned in this advantageous location requires an unimpeded clearance length L along the sub-scanning axis for receiving a printing plate and forming alignment features on the printing plate. As is illustrated in FIG. 6, length L is generally co-extensive with at least a portion of sub-scanning axis SSA that is occupied at least in part by one of the printing plates 24 and 26.

This means that neither of the printing plates can be moved directly into punch area 70. Accordingly, a plate positioning system 80 is provided that is operable to position each of printing plates 24 and 26 along the sub-scanning axis SSA. In the embodiment that is illustrated in FIGS. 1-6, plate positioning system 80 comprises a positioning actuator 82 driving a contact surface 84 to adjust the position of printing plates 24 and 26 along the sub-scanning axis so that only one of printing plates 24 and 26 are within the clearance length L. The positioning actuator 82 is adapted to drive contact surface 84 to selectively position the printing plates along the sub-scanning axis SSA so that only one of the printing plates is positioned for punching and further positioning the alignment edge 52 of first printing plate 24 in a manner that is aligned along the sub-scanning axis SSA with at least one of the alignment surfaces so that the alignment edge of the printing plate can be positioned against selected ones of the plurality of punch registration members.

It will be appreciated that positioning actuator 82 and contact surface 84 can take any number of forms including, but not limited to, a motor that drives a screw that extends along the sub-scanning axis and the rotation of which alters the sub-scanning axis position of a threaded nut on contact surface 84. Alternately and without limitation, positioning actuator 82 can include a motor that drives timing belts, chains, rack elements, associated pulleys, sprockets, gears, an hydraulic system or a pneumatic system. Similarly, contact surface 84 can be adapted to act on only one of the printing plates at a given time or can comprise a contact surface 84 with a plurality of contact pads.

In order to position the alignment edge of the first printing plate against the selected ones of the punch registration members, it is typically necessary to advance the printing plate along the main scanning axis MSA to engage beyond an edge of transfer support surface 60 prior to punching of the alignment surfaces. One mechanism for doing this is a registration bar 86 that can be used to grip or otherwise engage a first printing plate 24 and a registration bar actuator 88 that is used to advance first printing plate 24 along the main scanning axis to a position where alignment edge 52 of first printing plate 24 contacts the selected punch registration members 76a-76f. Alternatively other structures can be provided to achieve a similar movement of first printing plate 24 along the main scanning axis MSA and for moving printing plate against the selected punch registration members.

It will be appreciated that in the illustration of FIG. 5 and 6, a punch area 70 is shown having a fixed arrangement of punch drivers 72. However, these punch drivers 72 can be selectively actuated, moved, or removed to provide variable arrangements of alignment features in a printing plate. For example some of the punch drivers 72 can be moved laterally along the sub-scanning axis and others can be moved along the main scanning axis. Such movements of the punch drivers 72 can be made manually or automatically.

In the embodiment illustrated, a load table 90 is provided and is adapted to exchange printing plates 24 and 26 with imaging support surface 28 either before imaging and punching or afterward.

To help automate operation of printing plate processing system 10, a plurality of sensors are provided for sensing when printing plates 24 and 26 are positioned against the alignment surfaces on imaging support surface 28. In one embodiment such sensors 91 include defining alignment surfaces 40-50 as an electrically isolated conductors arranged so that when a, typically metallic, printing plate is in registration on the imaging support surface 28, the electrically conductive printing plate defines an electrical connection between all of the electrical conductors; and, an electrical circuit adapted to sense an electrical connection between all of the conductors and to thereupon generate an output signal that is detected by the controller and used to determine when proper loading of the printing plates has occurred. Embodiments of such a system are disclosed separately in U.S. Pat. No. 6,510,793, entitled “Imaging apparatus and printing plate mounting surface for use in an imaging apparatus having printing plate registration detection” issued to Kerr et al. on Jan. 28, 2003. It will be appreciated that other edge sensing systems can be used to detect when printing plates are properly loaded on imaging support surface 28.

Additional sensors can include a transfer surface position sensor 92 and a plate positioning sensor 94. Transfer surface position sensor 92 detects the position of transfer support surface 60 and provides a signal from which it can be determined when transfer support surface is at the transfer position and when the transfer support surface is at the fabricating position. Plate positioning sensor 94 generates signals from which the position of contact surface 84 can be determined and from which the extent of movement of printing plates 24 and 26 along the sub-scanning axis can likewise be determined.

Controller 20 can comprise a microprocessor such as a programmable general purpose microprocessor, a dedicated micro-processor or micro-controller, or any other system that can receive signals from sensors 91, and from external and internal data sources and that can generate control signals to cause actuators and motors within printing plate processing system 10 to operate in a controlled manner to form imaged printing plates having alignment features thereon.

Example Method for Plate Imaging and Alignment Feature Punch.

For the purpose of the following discussion, one example of a method for operating printing plate processing system 10 will be described. Specifically, in the embodiment illustrated in FIGS. 1-6 it will be assumed that it is desired to operate imaging system 14 in a manner that records images on the printing plates 24 and 26 before fabricating alignment surfaces on printing plates 24 and 26. However, it will be appreciated that this is done for convenience only and that the printing plate processing system 10 of the invention can be operated in “punch first” mode with equal facility.

In this example, load table 90 is adapted to receive printing plates 24 and 26 before printing plates 24 and 26 are imaged and before alignment surfaces are punched thereon. Load table 90 stores printing plates 24 and 26 prior to initiation of an imaging operation using printing plates 24 and 26 and provides printing plates 24 and 26 at imaging support surface 28 so that they can be positioned on imaging support surface 28 as desired. In a typical application load table will receive printing plates from a storage facility that stores the printing plates in a cassette.

During a loading process, printing plates 24 and 26 are moved from load table 90 and onto imaging support surface 28. As discussed above, alignment edge 52 of first printing plate 24 is positioned against first imaging alignment surfaces 40 and 42 to define a location of printing plate 24 along the main scanning axis MSA when an image is formed on first printing plate 24. Similarly, alignment edge 54 of second printing plate 26 is positioned against first imaging alignment surfaces 40 and 42 to define a location of second printing plate 26 along the main scanning axis MSA when an image is formed on second printing plate 26.

When first printing plate 24 and second printing plate 26 are positioned against all of the alignment surfaces, controller 20 receives a signal from plate positioning sensor 94 and activates the attraction system (not shown) to hold the printing plates 24 and 26 in a fixed position on imaging support surface 28. Controller 20 then sends signals to imaging head 22 and motor 36 causing imaging head 22 to begin directing image forming energy toward printing plates 24 and 26 while also causing motor 36 to rotate. This process continues until images are formed on printing plates 24 and 26. As used herein the term image and images are intended to generically include any form of marking or contact indicia that can be transferred by way of contact printing, including without limitation pictorial images, text, graphics, tactile information, and embossments.

After printing is complete, controller 20 causes a transfer actuator 64 to move transfer support surface 60 until transfer surface position sensor 92 detects that transfer support surface 60 is in the transfer position.

Controller 20 then uses plate exchange surface 17 and plate exchange actuator 18 to transfer printing plates 24 and 26 onto transfer support surface 60. Plate exchange surface 17 typically comprises a holding structure through which a holding force, such as a clamping or other mechanism force, a vacuum, electrostatic or magnetic force to hold the printing plates in a generally fixed position relative thereto. Plate exchange actuator 18 moves plate exchange surface 17 to reposition printing plates held by the holding force.

In the embodiment illustrated in FIG. 6, exterior surface 34 acts as plate exchange surface 17 and motor 36 is used as plate exchange actuator 18. Accordingly in this embodiment, controller 20 causes motor 36 to rotate so that an edge of printing plates 24 and 26 that is not positioned against the alignment surfaces is advanced toward transfer support surface 60 while also, at least in part, relaxing the extent to which attractive forces are applied to printing plates 24 and 26. In the embodiment that is illustrated, when transfer support surface 60 is in the transfer position, a portion thereof is interposed into a path of travel of printing plates 24 and 26 with attractive forces relaxed so that printing plates 24 and 26 are advanced onto transfer support surface 60. It will be appreciated that in so doing, printing plates 24 and 26 are advanced onto transfer support surface 60 with alignment edges 52 and 54 positioned respectively at an end of transfer support surface 60 that is proximate to punch area 70.

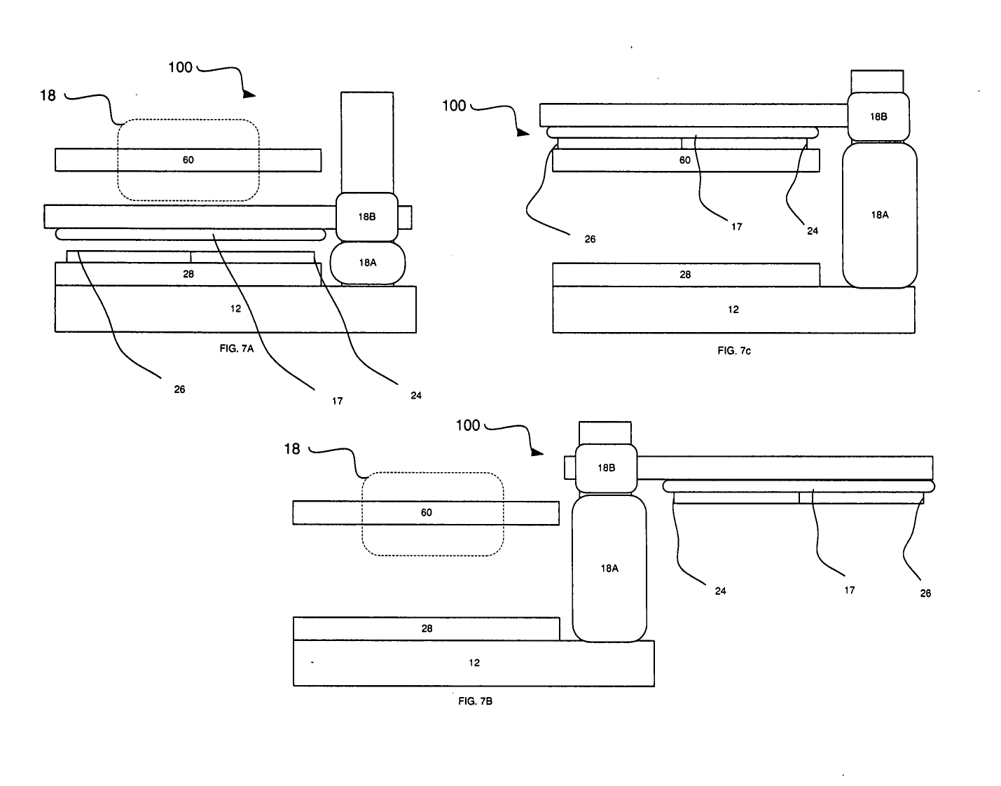

In other embodiments, such as the embodiment of FIGS. 7A-7C where, for example, imaging support surface 28 comprises a plate or other structure that is not associated with an actuator or in any other situation wherein it is not desired to use imaging support surface as a plate exchange surface other well known assemblies can be used to provide plate exchange surface 17 and plate exchange actuator 18 examples including so-called pick and place transfer assemblies, robotic assemblies or non-robotic assemblies. In FIGS. 7A-7C, one such pick and place assembly 100 is shown with magnetic plate acting as a plate exchange surface 17 and a plate exchange actuator 18 comprising a plurality of actuators 18a to move attracted plates vertically and 18b to move the attracted plates about a lifting axis (FIG. 7B) so that the plates can be moved to the transfer support surface 60 (FIG. 7C).

After transfer of printing plates 24 and 26 onto transfer support surface 60, controller 20 then causes transfer actuator 64 to drive transfer support surface 60 along a path defined by positioning system 62 to a point wherein transfer surface position sensor 92 detects that transfer support surface 60 is in the punch position.

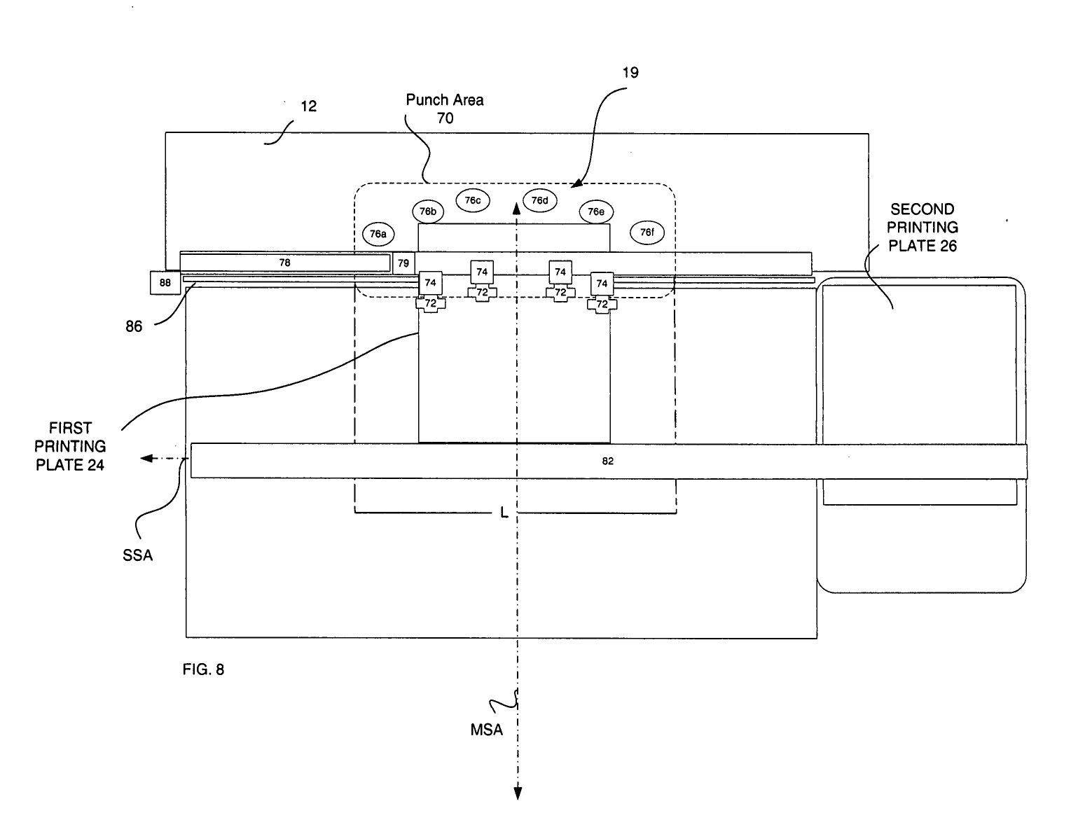

Controller 20 then selects one of first printing plate 24 and second printing plate 26 for initial presentation to the punch area 70. Controller 20 then causes plate positioning system 80 to position the selected printing plate with an alignment edge confronting selected ones of punch registration members 76a-76f of punch area 70 and, as necessary, to move the non-selected printing plate to a position that does not interfere with the punch of alignment surfaces with the selected plate. An example of this is shown in FIG. 8. In FIG. 7, first printing plate 24 is shown selected for punching while second printing plate 26 is moved to a storage area 96 which can be on or off of transport support surface 60. This will involve selecting a position along the sub-scanning axis within which to locate the selected printing plate, e.g. first printing plate 24, so that the alignment of the printing plate is positioned confronting a pair of selected registration members and positioning the printing plate against the selected registration members. The number of registration members against which a particular printing plate can be positioned can include as few as one registration member and any other number greater than one. As is discussed above, in certain embodiments it may be necessary to use registration bar and registration bar actuator or some other structure to advance the printing plate along the main scanning axis MSA and against such alignment features.

It will be appreciated that the selection of punch registration members can also consider factors such as the overall size of the printing plate and the alignment of the printing plate during imaging operations.

Controller 20 selects at least one punch registration members 76a-76f for use in positioning a particular printing plate along the main scanning axis based upon the arrangement of alignment surfaces that were used to form the image on the printing plate printing plate. Typically there will be a predetermined correspondence between the punch registration members used in forming alignment features and the alignment surface used in forming an image on the printing plate. Such correspondence can be stored, for example, in a memory 21 that can be accessed by controller 20 as necessary during imaging and alignment feature formation or can be calculated by controller 20 based upon known relationships.

Controller 20 causes particular ones of the punch registration members to be used by using plate positioning system 80 to define a location for the printing plate along sub-scanning axis SSA during the punching operation such that when the registration bar 86 or some other structure advances the printing plate along the main scanning axis, the alignment edge of the printing plate will be positioned along the main scanning axis by contact with the selected punch registration member or members. Because each printing plate is positioned along the main scanning axis with respect to the alignment edge both during imaging and during formation of the alignment features, and because controller 20 determines the location of the alignment features based upon the location of the image, plate-to-plate variations along the main scanning axis can be minimized.

Once that the alignment edge of the printing plate is so positioned, controller 20 can cause the lateral alignment feature 78 to be advanced by the lateral displacement system 79 to provide refined adjustment of the printing plate along the sub-scanning axis so that the alignment features of the printing plate are formed at a preferred position along the sub-scanning axis. The preferred position is determined based upon the position of the image formed on the printing plate, said image being formed relative to the position of the lateral alignment edge. Because controller 20 selectively causes an image to be formed on each printing plate at a position that is based upon the location of the lateral edge and also positions the alignment features with respect to the location of the lateral edge plate-to-plate variations along the sub-scanning axis SSA can be substantially minimized.

In one embodiment, controller 20 does this by determining for each printing plate a main scanning axis separation between the alignment edge and the image formed thereon and a sub-scanning axis separation between a lateral edge of the printing plate and the image formed thereon. During alignment surface formation, controller 20 causes plate positioning system to advance each one of the plurality of printing plates along the main scanning axis until the alignment edge of the printing plate comes into contact with a registration member in punch area 70 that is located so that the printing plate will be positioned to have alignment features formed by the punch area 70 at a position along the main scanning axis that is determined based upon the main scanning axis separation for the printing plate. Controller 20 can then cause the lateral alignment feature 78 and lateral displacement system 79 to adjust the position of the lateral edge of each one of the printing plates so that punch drivers 72 in punch area 70 will form said alignment features in each printing plate at a position along the sub-scanning axis relative to the lateral edge of the printing plate that is determined based upon the sub-scanning axis separation for the printing plate.

It will be appreciated that in this way, a printing plate processing system 10 is provided with highly accurate controls over the positioning of the alignment features and the image formed on a printing plate.

The term “actuator” has been used in the present disclosure to generically describe any form of automation that can convert or use energy to cause one structure to move relative to a reference point. These structures can include without limitation motors, solenoids, pneumatic cylinders, hydraulic cylinders, or any known engine of any type and the term actuator is deemed to be inclusive of any known mechanical structures capable of converting energy provided in a form useful in the manner described herein including, but not limited to, any known form of mechanical or electromechanical transmission.

The invention has been described in detail with particular reference to certain preferred embodiments thereof, but it will be understood that variations and modifications can be effected within the spirit and scope of the invention.

### PARTS LIST

10 printing plate processing system
12 frame
14 imaging system
16 transfer assembly
17 plate exchange surface
18a-b plate exchange actuator
19 alignment surface punch system
20 controller
21 memory
22 imaging head
23 integral edge detector
24 first printing plate
25 lateral edge
26 second printing plate
27 lateral edge
28 imaging support surface
30 light emission channel
32 light emission channel
34 exterior surface
36 motor
38 threaded screw
40 first imaging alignment surface
42 first imaging alignment surface
44 second imaging alignment surface
46 second imaging alignment surface
48 first sub-scanning axis alignment surface
50 second sub-scanning axis alignment surface
52 alignment edge of first printing plate
54 alignment edge of second printing plate
60 transfer support surface
62 positioning system
64 transfer actuator
70 punch area
72 punch drivers
73 punch
74 punch actuators
76a-76f punch registration members
77 printing plate
78 lateral alignment feature
79 lateral displacement system
80 plate positioning system
82 positioning actuator
84 contact surface
86 registration bar
88 registration bar actuator
90 load table
91 sensors
92 transfer surface position sensor
94 plate positioning sensor
96 storage area
100 pick and place assembly
L length of punch area clearance area along sub-scanning axis
MSA main scanning axis
SSA sub-scanning axis

1. A printing plate processing system:
an imaging system having an imaging head adapted to record an image on each of a plurality of printing plates loaded on an imaging support surface during an imaging operation; said imaging support surface having a plurality of imaging alignment surfaces with each printing plate being associated with a set of imaging alignment surfaces and against which an alignment edge of each printing plate can be positioned during said imaging operation;
said plate exchange surface and plate exchange actuator operable to transfer the plurality of printing plates between the imaging surface and the transfer support surface for concurrent processing;
a transfer assembly having a transfer support surface sized to hold the plurality of printing plates at the same time and a transfer surface positioning system defining a movement path for the transfer support surface between a transfer area wherein printing plates can be exchanged with a plate transfer support surface and a punch area;
a plurality of punch registration members arranged in the punch area in a distribution that allows the alignment edge of a single one of a plurality of printing plates moved to the punching area to be positioned against any of the punch registration members so that the received printing plate is positioned at one of a variety of positions relative to a plurality of punch drivers adapted to automatically punch alignment features in the positioned printing plate;
a plate positioning system operable to individually position each of the printing plates against at least one of the punch registration members; and
a controller adapted to cause the imaging system to record an image on each of the printing plates when each printing plate is positioned for imaging; said controller further causing the plate exchange surface and plate exchange actuator to exchange printing plates between the transfer support surface and the imaging surface; said controller further causing the plate positioning system to position the alignment surface of each of the printing plates against at least one of the punch registration members selected to correspond with the set of imaging alignment surfaces associated with the printing plate, and to cause at least one of the punch drivers to form an alignment feature in each positioned printing plate.

2. The system of claim 1, wherein selected ones or selected combinations of punch registration members position printing plates at different relative positions along a main scanning axis.

3. The system of claim 1, wherein the plate positioning system comprises an actuator and a contact mechanism adapted to move each member of the plurality of printing plates along a sub-scanning axis on the transfer support surface.

4. The system of claim 1, wherein the plate positioning system is further adapted to move a punched printing plate to another position at least in part supported by a structure other than the transfer support surface.

5. The system of claim 1, wherein the punch area is arranged in a punching length along a sub-scanning axis, said punching length being within a length along the sub-scanning axis that is occupied by at least two of the plurality of printing plates when the printing plates are positioned on the transfer support surface wherein the plate positioning system is adapted to reposition at least one of the at least two of the plurality of printing plates outside of the punching length before positioning another of the printing plates so that the alignment surface thereof contacts a selected set of the punch registration members.

6. The system of claim 1, further comprising an edge detector adapted to sense a lateral edge of each printing plate along a sub-scanning axis during image formation, wherein said controller positions the images formed on the printing plates based upon the sensed location of the lateral edge.

7. The system of claim 6, further comprising a lateral alignment feature adapted to engage the printing plate received at the punch area and a lateral displacement system adapted to adjust the position of the printing plate along the sub-scanning axis to a position that is determined at least in part based upon the relative positions of image recorded on the printing plate and a lateral edge of the printing plate located along the sub-scanning axis.

8. The system of claim 1, wherein said plate exchange surface comprises said imaging support surface and wherein said plate exchange actuator comprises an actuator that is adapted to move the imaging plate relative to the transport system, wherein said controller is adapted to determine when the transport surface is in the exchange area and to then execute a plate exchange by moving the imaging surface in a direction that pushes the printing plates to a position wherein the plates contact and are driven onto the transport surface.

9. The system of claim 1, wherein the plate exchange surface and plate exchange actuator comprise a holding structure adapted to apply an energy to hold at least one of the printing plates in a fixed position relative thereto and at least one plate exchange actuator adapted to move the holding structure between a position on the imaging support surface and a position on the transfer support surface.

10. A printing plate processing system comprising:
an imaging support surface adapted to concurrently support both of a first printing plate and a second printing plate with an alignment edge of the first printing plate being positioned relative to a first set of imaging alignment surfaces and with an alignment edge of the second printing plate being positioned against a second set of imaging alignment surfaces;
an imaging head adapted to form images on the first and second printing plates so positioned;
a transfer assembly having a transfer support surface adapted to receive the first and second printing plates and a transfer surface positioning system adapted to provide controlled movement of the transfer support surface from a position where the first and second printing plates can be exchanged with the imaging support surface and a punch position;
a plurality of punch registration members disposed on a punching support surface to engage an alignment edge of a single on of the plurality of printing plates on the transfer support surface when the transfer support surface is at the punch;
a plurality of punches and associated punch actuators positioned with respect to the plurality of punch registration members, said actuators being activatable to cause selected ones of the punches to form alignment features on a printing plate positioned against any of the plurality of punch registration members;
a first electronic sensor generating a first signal when the transfer support surface is at the punching position;
a controller operable for detecting the first signal, and in response thereto, cause:
a plate positioning system to position the first printing plate in an aligned relationship with registration members selected from the plurality of punch registration members that correspond with the first set of imaging alignment surfaces;
a punch driver to activate the at least one of the punch actuators to punch the first printing plate so that alignment features are formed on the first plate in a location that is based upon the location of the alignment edge of the first printing plate that engages the punch registration members selected for the first printing plate;
said plate positioning system further being adapted to reposition the first printing plate apart from the punch area after punching of the first printing plate and to position the second printing plate in an aligned relationship with registration members that correspond with the second set of imaging alignment surfaces; and
a punch driver to activate at least one of the punch actuators to punch the second printing plate so that alignment features are formed on the second plate in a location that is based upon the location at which the alignment edge of the second plate engages the registration members selected for the second printing plate.

11. The printing plate processing system of claim 10, wherein the first and second sets of alignment surfaces are separated from one another by a first sub-scan spacing, and wherein the punch registration members selected for the first printing plate and second printing plate are separated by a second sub-scan spacing, the second sub-scan spacing being different from the first sub-scan spacing.

12. The printing plate processing system of claim 10, wherein the first set of alignment surfaces is positioned at a first sub-scan position and the registration members selected for the first printing plates are positioned at a second sub-scan position, wherein the first and second sub-scan positions are common to both the image support surface and the transfer support surface, and both the first and second sub-scan positions are not the same position.

13. The printing plate processing system of claim 10, further comprising an edge detector adapted to sense a lateral edge of each printing plate along a sub-scanning axis during image formation, wherein said controller positions the images formed on the printing plates based upon the sensed location of the lateral edge.

14. The printing plate processing system of claim 13, further comprising a lateral alignment feature adapted to engage the printing plate received at the punch area and a lateral displacement system adapted to adjust the position of the printing plate along the sub-scanning axis to a position that is determined at least in part based upon the relative positions of image recorded on the printing plate and a lateral edge of the printing plate located along the sub-scanning axis.

15. A printing plate processing system comprising:
an imaging drum having an external surface, said imaging drum being connected to a motor to controllably rotate the drum along a scanning axis and having sufficient length along a sub-scanning axis to receive more than one printing plate;
at least one imaging head adapted to form images on printing plates loaded on the external surface;
a transfer assembly adapted to automatically move a plurality of printing plates from the external surface of the imaging drum proximate to the punching position;
a plate exchange surface and plate exchange actuator operable to transfer the plurality of printing plates between the imaging surface and the transfer support surface;
a plurality of punches each associated with a punch actuator; said punches and punch actuators being adapted to punch any of a set of differently located alignment features in a printing plate that is positioned in one of a plurality of punching positions;
a printing plate positioner having an electrically controlled actuator and a contact surface movable by the actuator to advance only one of the printing plates at a time to one of the plurality of punching positions;
a first electronic sensor generating a first signal when the plurality of printing plates is loaded onto the external surface of the imaging drum; and
a controller operable detect the first signal and, in response thereto, to cause the motor and imaging head to cooperate to form images on the plurality of imaging plates loaded on the external surface of the imaging drum, said controller further being operable to cause the transfer support surface to receive the printing plates from the drum after the images have been formed on the plurality of printing plates and to position each printing plate proximate to the punching position, said controller further causing selected ones of the punch drivers to form alignment features in each of the plurality of printing plates after an alignment edge of the printing plate has been positioned along a sub-scanning axis so that when the printing plate is advanced along the main scanning axis, the alignment surface of printing plate contacts at least one of the punch registration members to position the printing plate along the main scanning axis at one of the punching positions;
said at least one contacted punch registration member selected to position the printing plate so that alignment features can be formed therein at a location that has a desired correspondence along a main scanning axis with the image formed on the printing plate.

16. The system of claim 15, further comprising an edge detector adapted to sense a lateral edge of each printing plate along the sub-scanning axis during image formation, wherein said controller positions the image formed on each of the printing plates based upon the sensed location of the lateral edge.

17. The system of claim 16, further comprising a lateral alignment feature adapted to engage the printing plate received and a lateral displacement system adapted to adjust the position of the printing plate along the sub-scanning axis to a position that is determined at least in part based upon the relative positions of image recorded on the printing plate and the sensed location of the lateral edge along the sub-scanning axis.

18. A method for positioning a printing plate for formation of alignment features therein, the method comprising the steps of:
positioning a plurality of printing plates on an imaging support surface;
forming an image on each printing plate at a location that is separated by a main scanning axis separation from an alignment edge that is perpendicular to a main scanning axis;
transporting the plurality of printing plates to a position proximate to a punching area having punch drivers adapted to form alignment features in a printing plate;
individually selecting each one of the plurality of printing plates; and
advancing each selected one of the plurality of printing plates until the alignment edge thereof comes into contact with a registration feature in the punch area that is located so that the printing plate will be positioned to have alignment features formed by the punch drivers at a position along the main scanning axis that is determined based upon the main scanning axis separation for the selected printing plate.

19. The method of claim 18, wherein the image formed on each the printing plate is separated from a lateral edge of the printing plate along a sub-scanning axis by a sub-scanning axis separation, and further comprising the step adjusting the position of the lateral edge of each one of the printing plates so that the punch drivers will form said alignment features in the printing plate at a position along the sub-scanning axis relative to the lateral edge of the printing plate that is determined based upon the sub-scanning axis separation for the printing plate.
